(19) United States
(12) Patent Application Publication
(10) Pub. No.: US 2021/0361058 A1
(43) Pub. Date: Nov. 25, 2021

(54) Hose Attachment

(71) Applicant: David Linne, Charlevoix, MI (US)

(72) Inventor: David Linne, Charlevoix, MI (US)

(21) Appl. No.: 17/325,781

(22) Filed: May 20, 2021

Related U.S. Application Data
(60) Provisional application No. 63/028,499, filed on May 21, 2020.

(51) Int. Cl. A46B 11/06; B05B 15/65

(52) U.S. Cl. CPC A46B 11/063; B05B 15/65

(57) ABSTRACT

An attachment for use with a hose is provided. The attachment includes a body having a proximal end opposite a distal end. The body defines an inlet disposed at the proximal end. The body further defines an outlet at the distal end. The body defines an inner flow passage operable to enable water to flow from the inlet to the outlet. A connector is disposed at the proximal end of the body and is operable for attachment to a water source. A plurality of bristles is disposed at the distal end of the body and is operable for scrubbing a surface.

### CROSS REFERENCE TO RELATED APPLICATIONS

This application claims priority to U.S. Provisional Patent Application No. 63/028,499, filed May 21, 2020, the entirety of which is incorporated by reference as if fully disclosed herein.

### BACKGROUND OF THE INVENTION

### Field of the Invention

The present invention relates generally to attachments for garden hoses.

### General Background

Garden hoses are used for a myriad of reasons such as watering plants, filling a bucket, etc. But more often than not users reach for the garden hose to clean something. Most times a quick rinse is the intention—just pick up the hose and aim. Water is sprayed to wash away bird droppings, spider dots, brake dust on car wheels, and footprints, for example. But many of these messy problems do not wash away with water spray alone and require some scrubbing. Therefore, a need exists for an apparatus that eliminates the time required to acquire a brush and enable a user to quickly scrub a surface.

### SUMMARY OF THE INVENTION

In accordance with an embodiment of the invention, an attachment for use with a hose is provided. The attachment includes a body having a proximal end opposite a distal end. The body defines an inlet disposed at the proximal end. The body further defines an outlet at the distal end. The body defines an inner flow passage operable to enable water to flow from the inlet to the outlet. A connector is disposed at the proximal end of the body and is operable for attachment to a water source. A plurality of bristles is disposed at the distal end of the body and is operable for scrubbing a surface.

In accordance with another embodiment of the invention, an attachment for use with a hose is provided. The attachment includes a body having a proximal end opposite a distal end. The body defines an inlet disposed at the proximal end. The body further defines an outlet at the distal end. The body defines an inner flow passage operable to enable water to flow from the inlet to the outlet. A connector is disposed at the proximal end of the body and is operable for attachment to a water source. Means for scrubbing a surface is disposed at the distal end of the body.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts a front perspective view of a hose attachment in accordance with embodiments of the invention.

FIG. 2 depicts a back perspective view of a hose attachment in accordance with embodiments of the invention.

FIG. 3 depicts a side perspective view of a hose attachment and a hose nozzle in accordance with embodiments of the invention.

FIG. 4 depicts a side perspective view of a hose attachment attached to a hose nozzle in accordance with embodiments of the invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

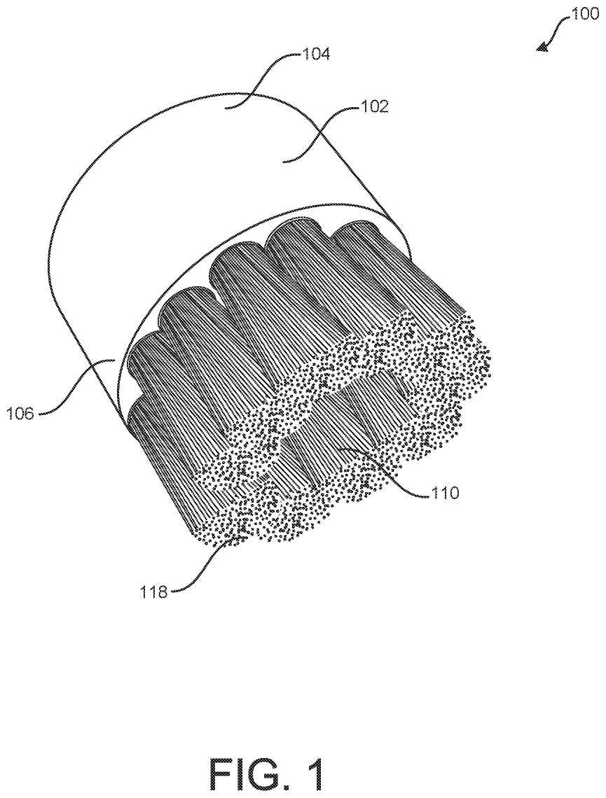

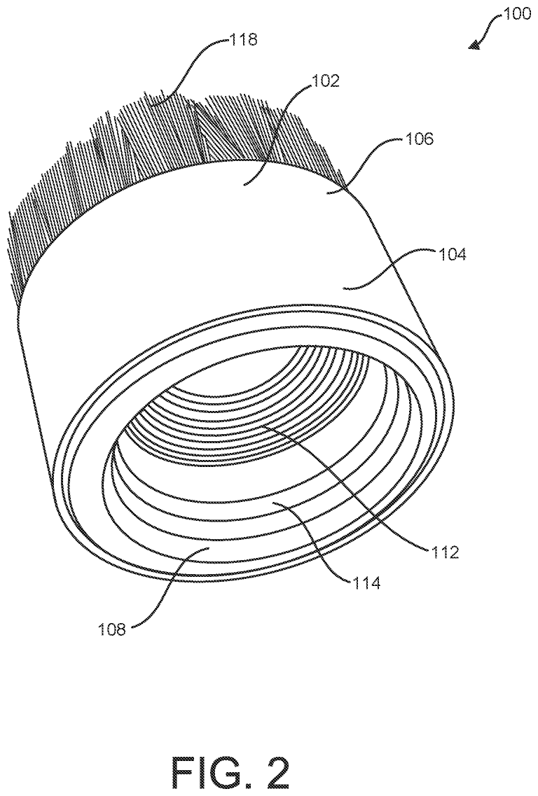

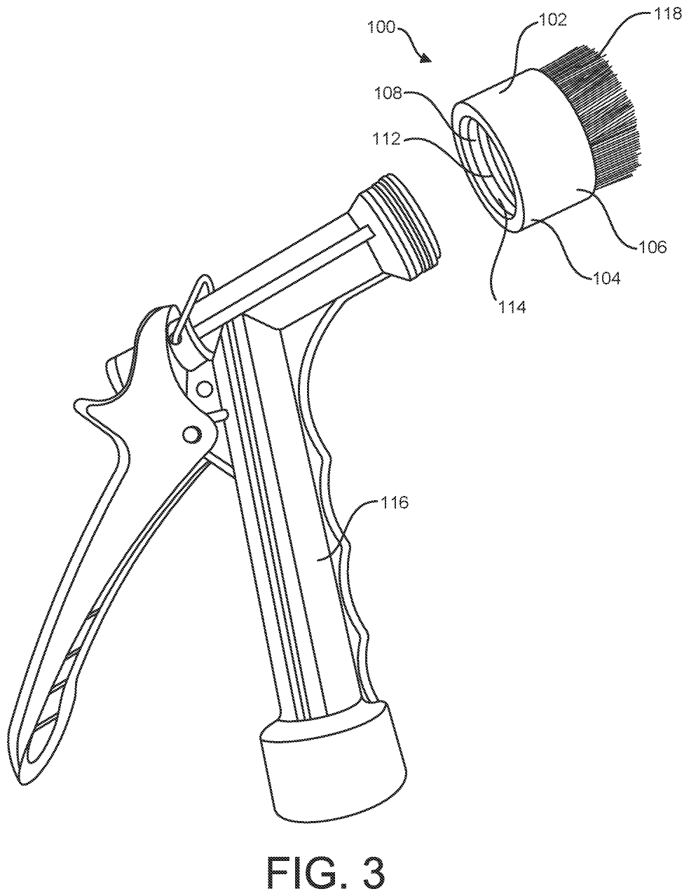

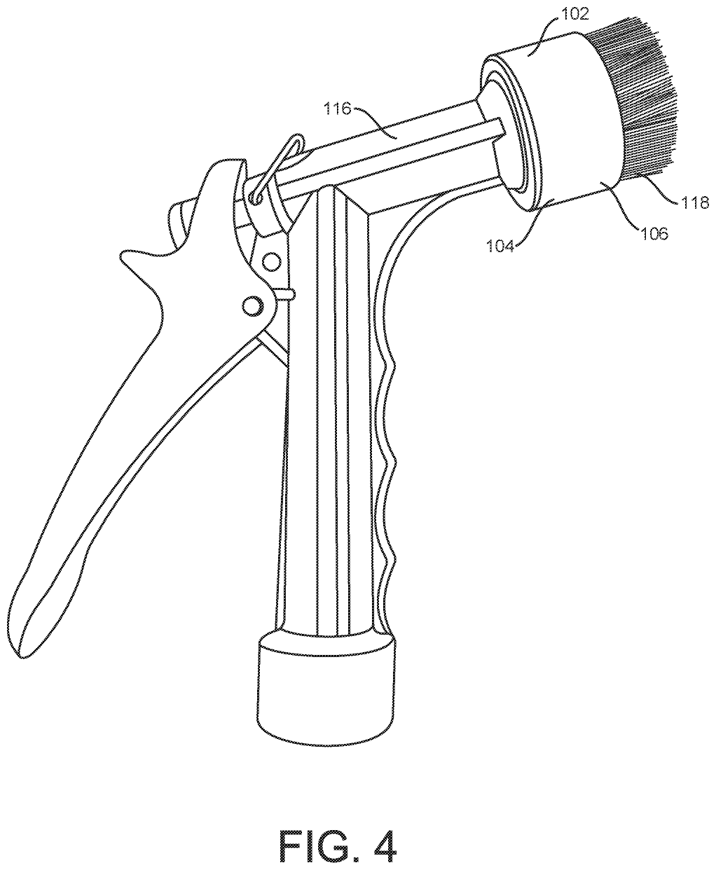

In accordance with embodiments of the invention, a hose attachment 100 is provided, as illustrated in FIGS. 1-4. The attachment 100 includes a body 102 having a proximal end 104 opposite a distal end 106. The body 102 defines an inlet 108 disposed at the proximal end 104 of the body 102. The body 102 may be fabricated of plastic injection molding, cast metal, machined metal, or 3D printed materials, for example. The body 102 defines an outlet 110 at the distal end 106 of the body 102. The body 102 defines an inner flow passage 112 operable to enable water to flow unimpeded from the inlet 108 to the outlet 110. A connector 114 is disposed at the proximal end 104 of the body 102 and is operable for attachment to a water source. As illustrated in the Figures, the connector 114 is a threaded connection operable for attachment to a garden hose or a nozzle, such as a trigger flow control nozzle 116, as illustrated in FIGS. 4 and 5, for example. Alternatively, the connector 114 may be a push on connector with a gasket, a quick connect attachment, or any suitable connection mechanism operable for a fluid tight connection to a hose or nozzle. As illustrated in the Figures, means for contacting a surface to clean or scrub the surface is a plurality of bristles 118, such as nylon bristles, is disposed at the distal end 106 of the body 102 and is operable for scrubbing a surface. Alternatively, the means for contacting a surface to clean or scrub the surface may be a brush, steel wool, a sponge, shammy cloth, sandpaper, chainmail, or any other suitable means for contacting, cleaning, or abrading a surface. The means for contacting the surface may be integrated within the body 102, such as the bristles 118 as illustrated in the Figures, or fastened to the body 102, for example.

In operation of the embodiment illustrated in the Figures, the attachment 100 is operable to screw onto threaded hose nozzles without impeding the water flow or adding significant weight. The attachment 100 avoids the need for a user to search for a brush when using a hose and encountering a surface that needs scrubbing for removing a hardened substance. Exemplary applications include cleaning deck furniture, railings, windows, window casings, boats, yachts, and automobiles, for example.

An advantage of the attachment 100 is the non-interference with normal use of a hose. Unlike prior art hose attachments, which burden the hose and the user with attaching and detaching, the attachment 100 does not have to be removed in order to use the hose as a user normally would. Water distribution is unimpeded when the attachment 100 is connected. When the need arises to scrub something, the attachment 100 is attached and ready to use.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. An attachment for use with a hose, comprising:
a body having a proximal end opposite a distal end, said body defining an inlet disposed at said proximal end, said body defining an outlet at said distal end, said body defining an inner flow passage operable to enable water to flow from said inlet to said outlet;
a connector disposed at said proximal end of said body, said connector operable for attachment to a water source; and
a plurality of bristles disposed at said distal end of said body, said plurality of bristles operable for scrubbing a surface.

2. The attachment of claim 1, wherein said connector is a threaded connection.

3. The attachment of claim 1, wherein said connector is operable for attachment to a garden hose.

4. The attachment of claim 1, wherein said connector is operable for attachment to a hose nozzle.

5. The attachment of claim 1, wherein said body is fabricated of plastic injection molding.

6. An attachment for use with a hose, comprising:
a body having a proximal end opposite a distal end, said body defining an inlet disposed at the proximal end, said body defining an outlet at said distal end, said body defining an inner flow passage operable to enable water to flow from said inlet to said outlet;
a connector disposed at said proximal end of said body, said connector operable for attachment to a water source; and
means for scrubbing a surface, said means disposed at said distal end of said body.

7. The attachment of claim 6, wherein said connector is a threaded connection.

8. The attachment of claim 6, wherein said connector is operable for attachment to a garden hose.

9. The attachment of claim 6, wherein said connector is operable for attachment to nozzle.

10. The attachment of claim 6, wherein said body is fabricated of plastic injection molding.

11. The attachment of claim 6, wherein said means for scrubbing a surface is a brush.

12. The attachment of claim 6, wherein said means for scrubbing a surface is a plurality of bristles.
